(19) United States
(12) Patent Application Publication
(10) Pub. No.: US 2006/0245867 A1
(43) Pub. Date: Nov. 2, 2006

(54) Doggie jogger

(76) Inventor: Stacey Lee Cunningham, San Diego, CA (US)

Correspondence Address: Stacey Lee Cunningham, 35 Independence Way, Rockaway, NJ, 07866, US

(21) Appl. No.: 11/027,537

(22) Filed: Dec. 30, 2004

(51) Int. Cl. B65G 67/00

(52) U.S. Cl. 414/401

(57) ABSTRACT

While some components and dimensions may vary from those described herein, the basic concept with its unique design features will not differ from the product. Such differences will be minor and have no effect on the basic concept and design or its intended use and operation.

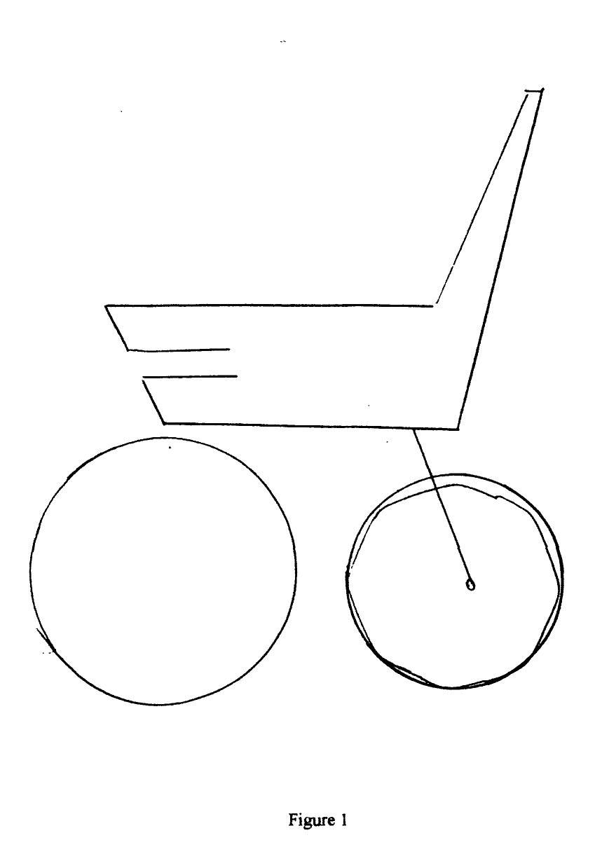

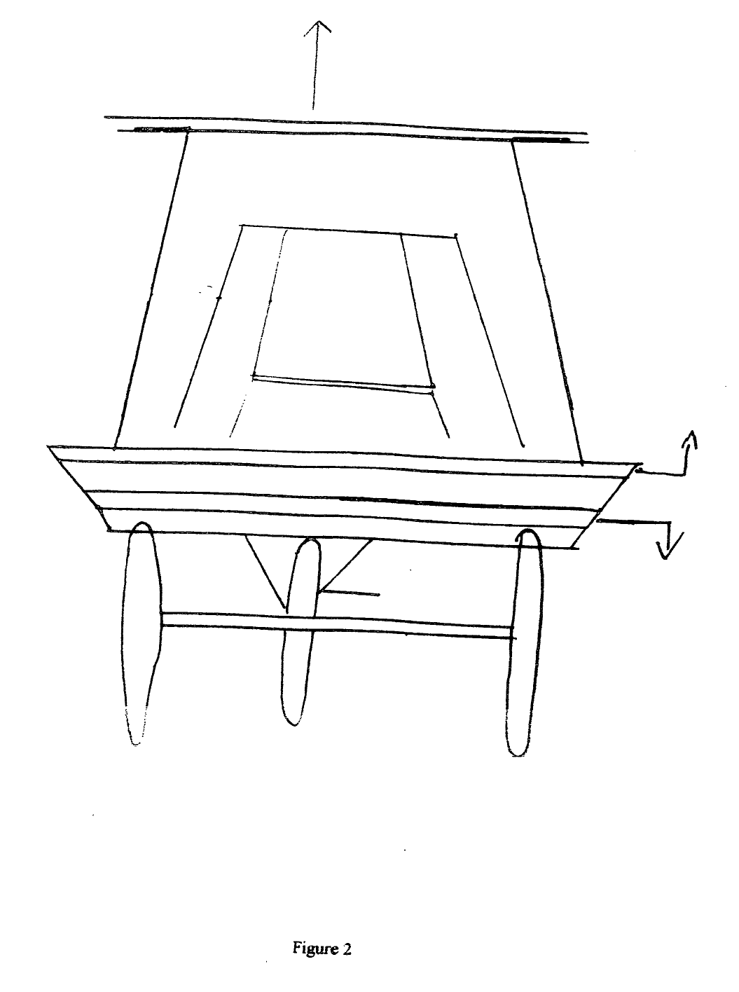

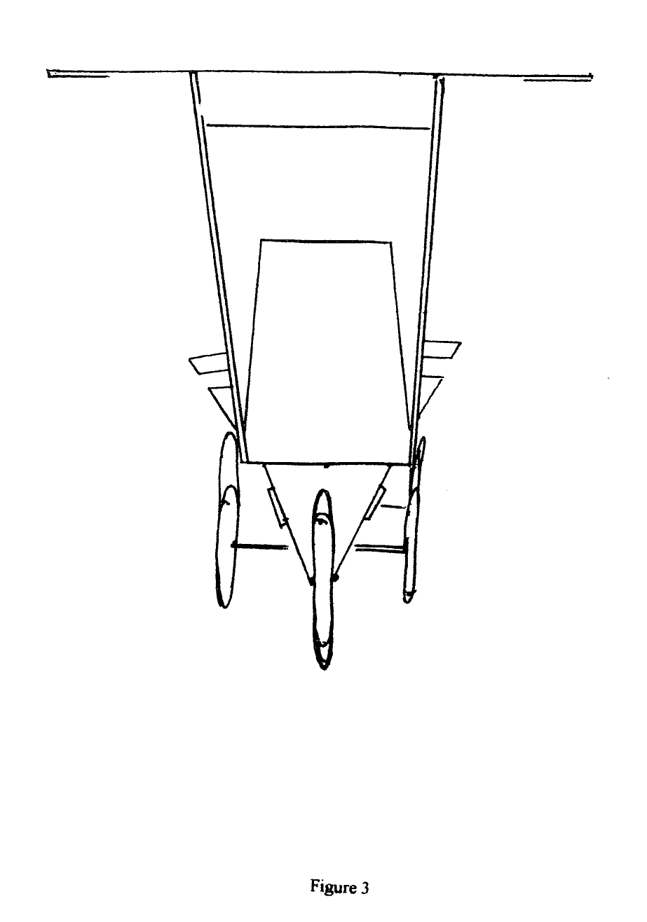

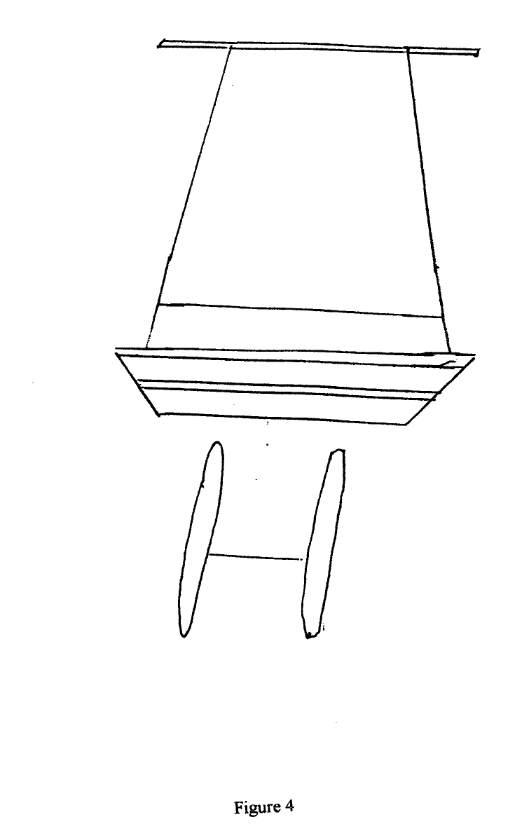

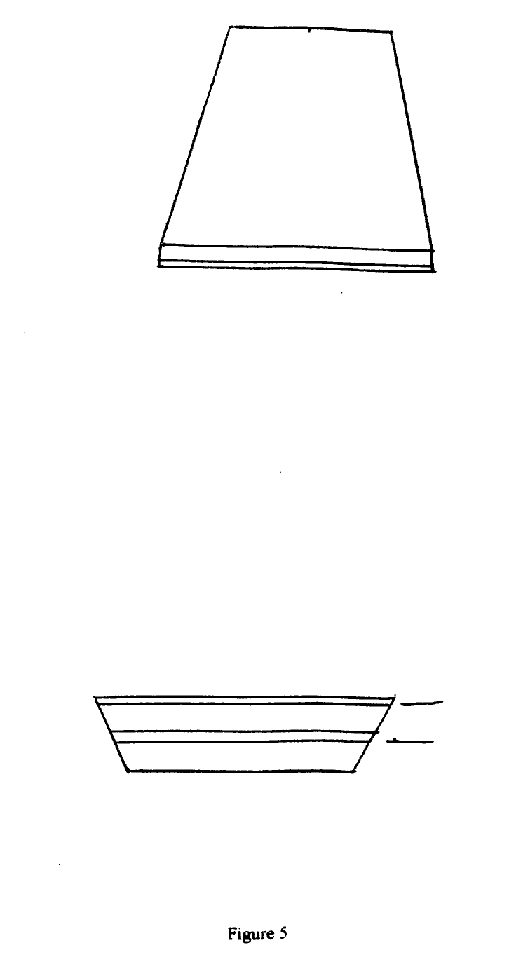

### ADVANTAGES OFFERED BY THIS PRODUCT

The doggie jogger will enable an individual who enjoys jogging or engaging in similar running activities with their pet on those occasions when the pet is not able or not inclined to run at the desired pace or distance. This could be due to the pet's age, health or a variety of reasons.

### LOAD CAPACITY

The doggie jogger is designed to support a pet weighting up to 130 lbs on the platform of the canvas or similar sturdy material. A framework of supporting bars secures the seating platform to other components of the doggie jogger.

Designed & Location of Wheels

The doggie jogger has three (3) sixteen inch (16″) wheels. Two (2) wheels are located forward with one (1) wheel located to the rear. All three (3) wheels have rubber air inflated tires similar to those typically found on most bicycles.

Overall Design

The doggie jogger has two (2) bars extending vertical from the undercarriage frame to either end of the horizontal control bar. The control bar, which is grasped by the operator, is approximately 2-3″ in diameter and 26″ in length. The control bar resembles a typical handle bar found on baby carriages. This design permits the individual gripping the horizontal control bar to jog or stroll at a comfortable pace while pushing and steering the doggie jogger.

Horizontal Breaking Bar

A breaking mechanism is connected to all three wheels and, via cable, extends to the horizontal breaking bar to reduce the speed or stop the doggie jogger. The horizontal breaking bar joins and becomes part of the horizontal control bar. This unique feature permits the owner to slow the doggie jogger with minimum effort by squeezing the breaking bar with either or both hands.

Inclement Weather Protection

An optional retractable cover is available and can be installed above the seating platform for pet owners who wish to provide protection against elements.

Storage Compartments:

Fitting attached to the two vertical bars extending from the undercarriage frame to the horizontal control bar can accommodate a water bottle or other containers. A canvas pouch, attached to the rear of the sitting platform, also provides additional storage accommodations for clothing, food, and etc. to meet the needs of the pet or the individual operating the doggie jogger.

Seating Platform:

The pet seating platforms is constructed of canvas or similar sturdy fabric. The shape of the sitting platform has a modified trapezoid shape. The front and rear sides of the seating platform are parallel with the front end of the platform wider than the rear.

Platform Dimensions:

The Approximate dimensions of the seating are as follows:

22″ across the front

12″ across the rear

30″ in length

The platform can be extended to rear by an adjustable canvas designed to support a large dog or, if desired, multiple pets sharing the seating platform.

Standing support Bars:

Two bars in the front of the seating platform are designed to support the pet in a standing position. The bars are covered in canvas and extend 2″-3″ beyond the seating platform and adjustable up to 12″

Additional Information:

Weight: Approximately 25 LBS. some optional features selected by the buyer will add to this.

Control bar height: Approximately 48″ from ground level.

Space between front wheels: Approximately 17-20″

Distance between front & rear wheels: approximately 14-16″

Summary:

While some components and dimensions may vary from those described herein, the basic concept with its unique design features will not differ from the product. Such differences will be minor and have no effects on the basic concept and design or its intended use and operation.

Side profile of the doggie jogger showing the plate form with the two bars in front. The two front rubber wheels which are 16 inches in size and the one rear rubber wheel 16 inches in size.

1. What separates the doggie jogger from other pet carriers is due to three designs.
The first is the triangle shape of the seat, which extends to the length to accommodate the length of the dog.
Second are the way the wheels are arranged, with one wheel in the rear and two in the front. This provided proper support of the weight of the dog.
Third is the standing support bars, which are designed to support the dog if he wishes to prop himself up. The first bar is closer to the dog and lower in height compared to the second bar. The second bar is higher and extends further out from the lower bar.
